(19) United States
(12) Patent Application Publication
(10) Pub. No.: US 2026/0017736 A1
(43) Pub. Date: Jan. 15, 2026

(54) DECISION SUPPORT TOOL FOR SELECTING PROPERTIES

(71) Applicant: Avvie Inc. dba Offerwell, Buffalo, NY (US)

(72) Inventor: Semaan T. MAHFOUD, Buffalo, NY (US)

(21) Appl. No.: 19/265,728

(22) Filed: Jul. 10, 2025

Related U.S. Application Data
(60) Provisional application No. 63/669,295, filed on Jul. 10, 2024.

(51) Int. Cl. G06Q 50/16; G06Q 30/0601

(52) U.S. Cl. CPC G06Q 50/16; G06Q 30/0631; G06Q 30/0641

(57) ABSTRACT

Decision support tool for real estate selection having at least one computer system and user interface. A content database of real estate properties includes spatial, temporal, material, risk, and financial variables for a set of at least one real estate property from the real estate properties, wherein the at least one real estate property can include a set of at least one real estate property with at least one second real estate property. At least one software program is disposed on at least one computer system designed to calculate user vectors wherein at least one machine learning program is designed to build the set of at least one real estate property from the real estate properties. The user interface is designed to receive inputs and present outputs wherein users may create user sets of at least one selected real estate property from the real estate properties.

### CROSS-REFERENCE TO RELATED APPLICATIONS

This application claims priority to and the benefit of U.S. Provisional Application 63/669,295, titled DECISION SUPPORT TOOL FOR SELECTING PROPERTIES, filed on Jul. 10, 2024, which is incorporated herein by reference in its entirety.

### FIELD

The present disclosure generally relates to a decision support tool for selecting properties, such as houses, designed to use data analytics and large language models to provide personalized property recommendations and comprehensive evaluations based on multiple factors and user preferences.

### BACKGROUND

Matching home buyers to homes that fit their budget, are conveniently located, and have desirable features presents several significant challenges. One primary issue is the complexity of aligning a buyer's financial constraints with the current housing market. Home prices can vary widely—even within a small geographical area, and factors like interest rates, property taxes, homeowners' association fees, and geographically-specific insurance needs, such as hurricane insurance, further complicate budget calculations. Buyers often need to compromise between what they want and what they can afford, which can be a difficult and stressful process, especially in competitive markets where bidding wars drive prices up and inventory may be limited.

Another challenge is ensuring the chosen home is conveniently located relative to the buyer's workplace, schools, and community amenities. Commute times, public transportation options, and proximity to essential services like grocery stores, healthcare facilities, and recreational areas all play crucial roles in the decision-making process. Balancing these logistical considerations with the availability of affordable homes can be particularly difficult in urban areas with high housing costs or rural areas with limited housing stock.

The availability of homes with appealing features is another significant hurdle. Buyers often have specific preferences regarding the number of bedrooms and bathrooms, layout, yard size, and modern amenities like updated kitchens or smart home technology. However, finding a home that meets all these criteria within a set budget and desired location can be rare. Additionally, the emotional aspect of home buying means that subjective preferences, such as the aesthetic appeal of a home or the feel of a neighborhood, also heavily influence decisions.

Finally, the process of matching buyers with suitable homes is often hampered by the limitations of real estate search tools and the availability of up-to-date information. Online listings may not always reflect the current status of a property, leading to wasted time on homes that are already under contract or have hidden issues. Real estate agents play a crucial role in navigating these challenges, but their effectiveness depends on their knowledge of the market and their ability to understand and prioritize their clients' needs and preferences, thus the lack of up-date-information also complicates the profession and may lead to inefficiencies. Consequently, the home buying process often involves extensive research, negotiation, and sometimes, compromises to find the best possible match.

There is a need in the market, therefore, for an improved tool to help match homes to prospective buyers.

### SUMMARY

According to aspects herein, disclosed is a decision support tool for real estate selection having at least one computer system having a controller assembly, memory assembly, and user interface. A content database of real estate properties includes spatial, temporal, material, risk, and financial variables for a set of at least one real estate property from the real estate properties, wherein the at least one real estate property can include a set of at least one real estate property with at least one second real estate property. The at least one real estate property is selected from the set of at least one real estate property and is designed to be compared by way of the computer system with the at least one second real estate property from the real estate properties. At least one software program is disposed on at least one computer system designed to calculate user vectors and property vectors wherein at least one machine learning program is designed to apply customizable filters, received via the user interface, to condition the user vectors by adjusting weights of the spatial, temporal, material, risk, or financial variables from which to build the set of at least one real estate property from the real estate properties to be presented to the user. The user interface is designed to receive inputs and present outputs wherein users may create user sets of at least one selected real estate property from the real estate properties.

Embodiments of the decision support tool for real estate selection may include the user interface having a dashboard designed to present at least one or more of: personalized recommendations, market analysis, property details, neighborhood insights, financial analysis, risk assessments, interactive maps, customizable filters: comparison tools, and human or chatbot assistance.

In some embodiments of the decision support tool for real estate selection, the dashboard includes customizable filters configured to condition the range of at least one or more of spatial, temporal, material, risk, and financial variables.

In other configurations of the decision support tool for real estate selection, the user interface is designed to include, present, and record video imagery of the at least one real estate property.

In some aspects of the decision support tool for real estate selection, the video imagery is created and presented substantially in real time.

In further possible embodiments of the decision support tool for real estate selection include at least one or more of photographic and computer-generated visual data.

In further configurations of the decision support tool for real estate selection, data for each at least one real estate property is tagged by way of a Large Language Model.

In other embodiments of the decision support tool for real estate selection, each at least one real estate property is given at least one score.

In other possible configurations of the decision support tool for real estate selection, user vectors from at least one user are compared with at least one user vector from at least one other user.

In alternative embodiments of the decision support tool for real estate selection, user vectors include both manually entered data and predicted data.

These and other objects, features, and advantages of the present invention will become readily apparent upon a review of the following detailed description of the invention, in view of the drawings and appended claims.

### BRIEF DESCRIPTION

Various embodiments are disclosed, by way of example only, with reference to the accompanying schematic drawings in which corresponding reference symbols indicate corresponding parts, in which:

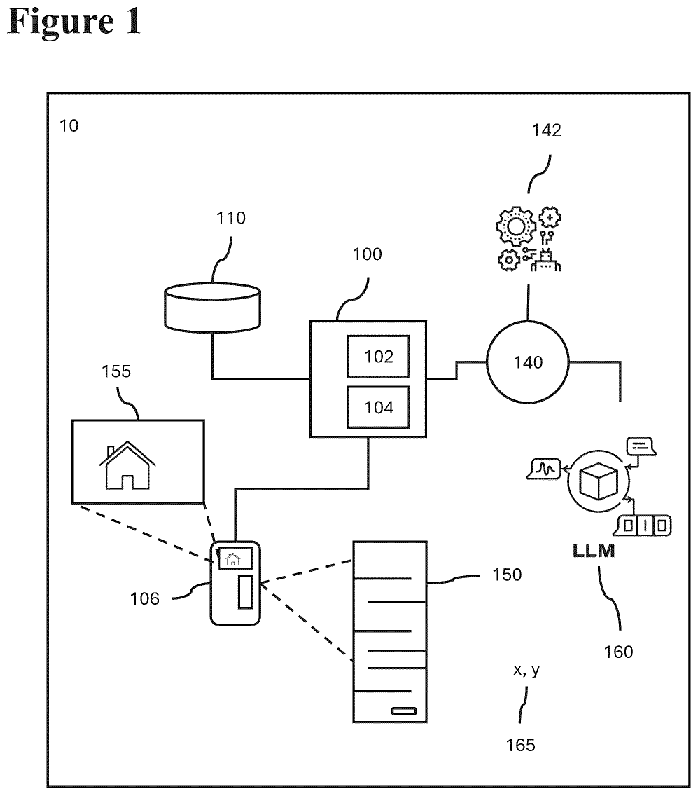

FIG. 1 illustrates a representative decision support tool;

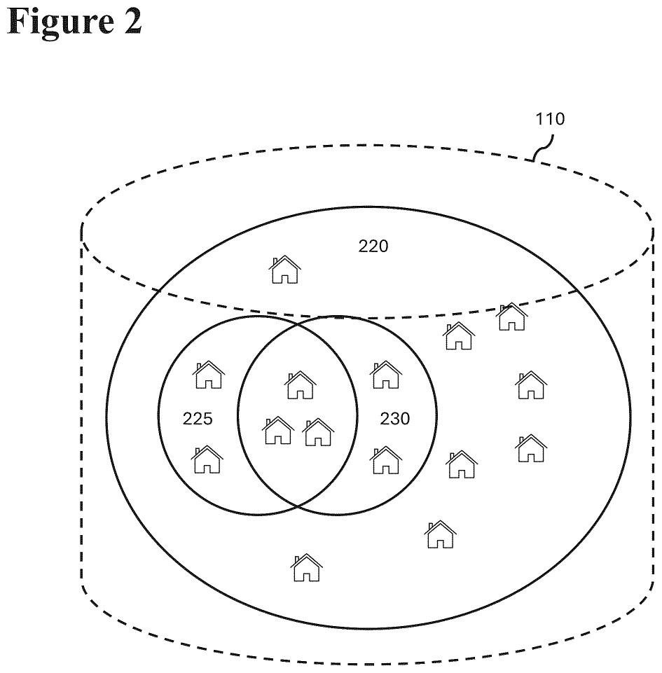

FIG. 2 illustrates sets of real estate properties;

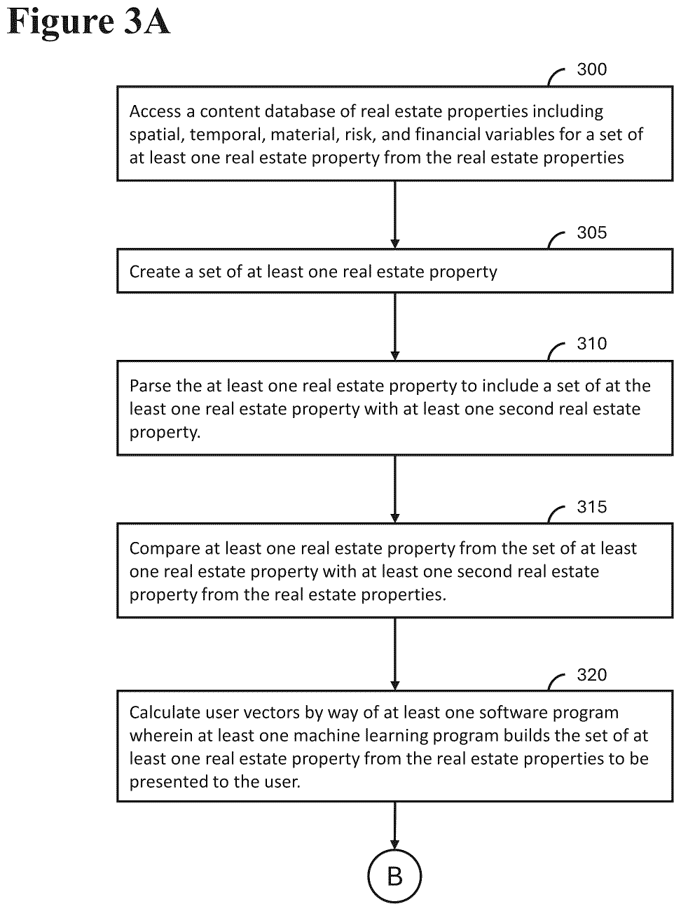

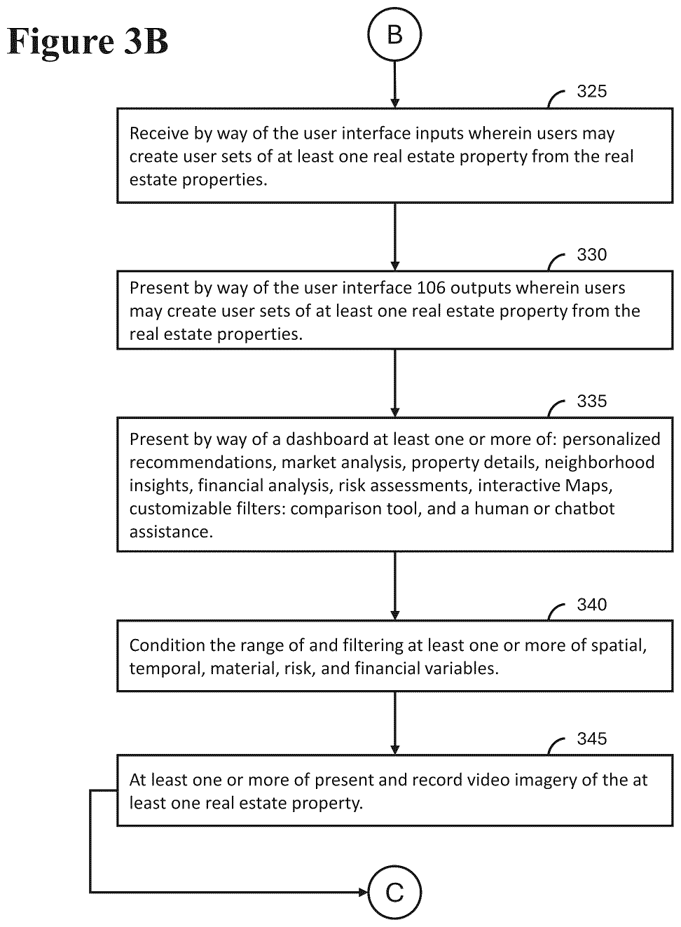

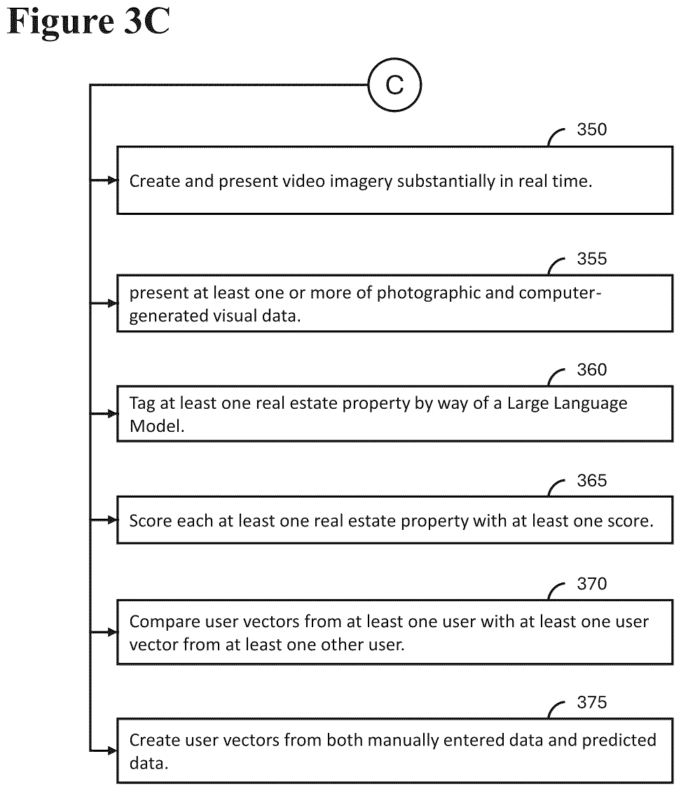

FIG. 3A-3C illustrates a representative decision support tool method;

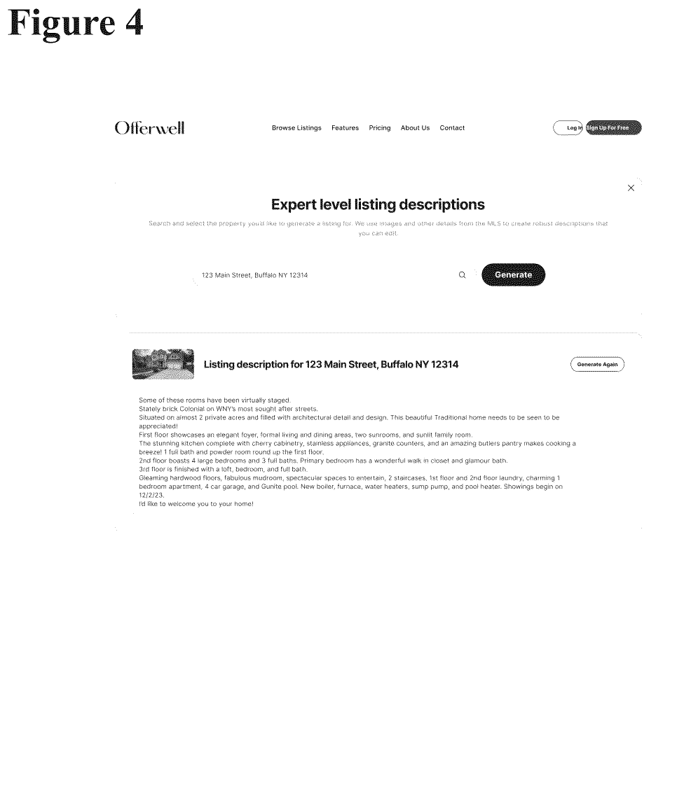

FIG. 4 illustrates a representative user interface screen image of real estate property description;

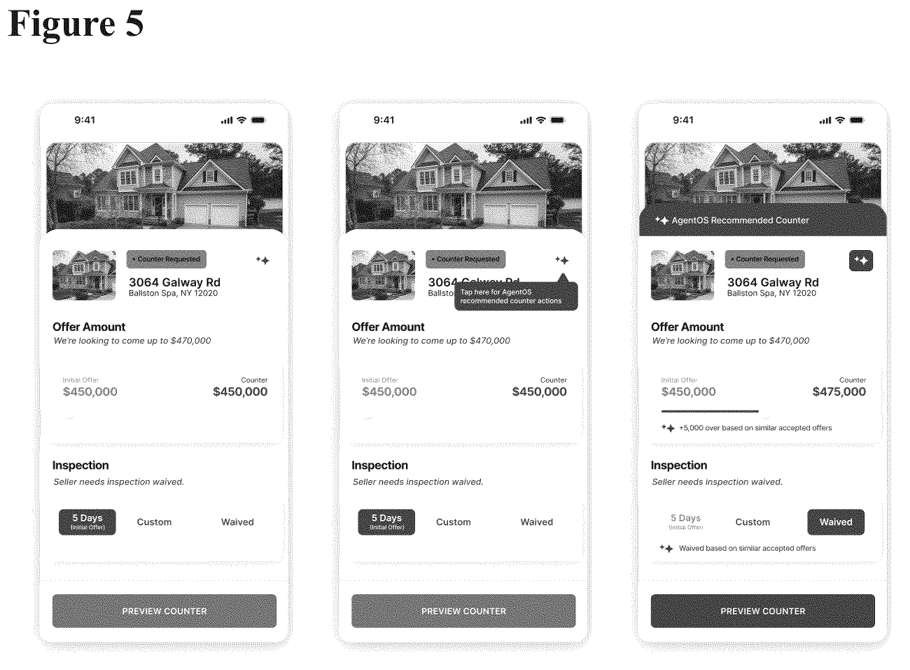

FIG. 5 illustrates a representative user interface screen image of comparative real estate property listings;

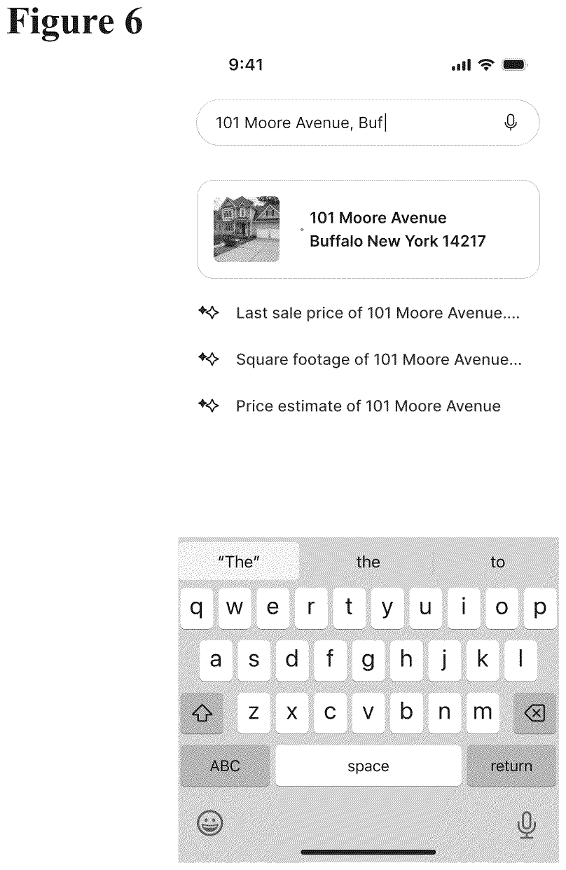

FIG. 6 illustrates a representative user interface screen image of real estate property information;

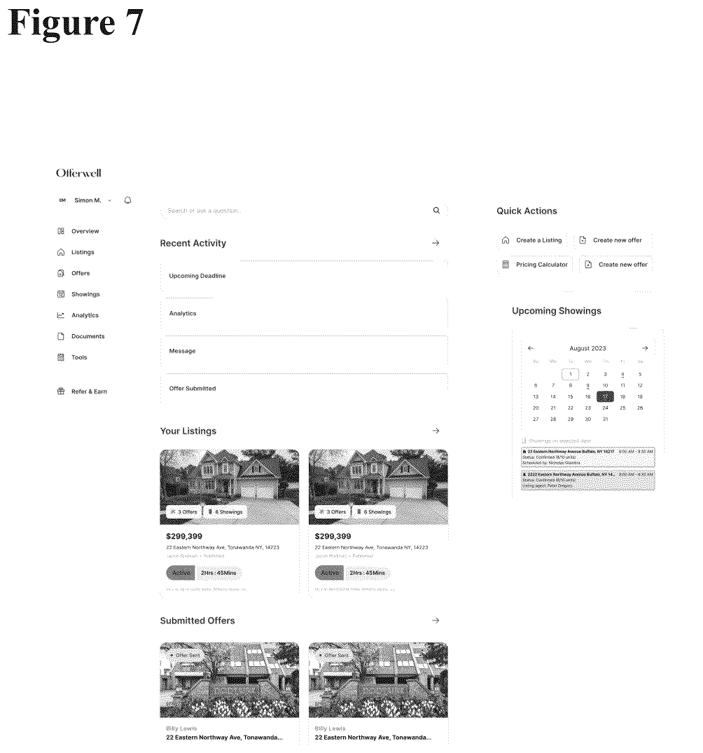

FIG. 7 illustrates a representative user interface screen image of real estate property quick action page; and

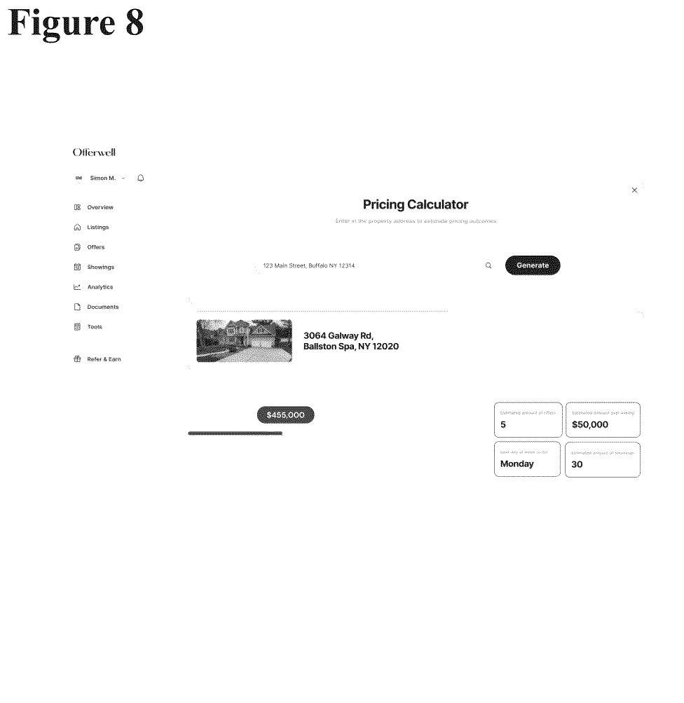

FIG. 8 illustrates a representative user interface screen image of real estate property pricing calculator.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims. Those in the art will understand that any suitable material, now known, or hereafter developed, may be used in forming the present invention described herein.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be noted that the terms “including”, “includes”, “having”, “has”, “contains”, and/or “containing”, should be interpreted as being substantially synonymous with the terms “comprising” and/or “comprises”.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. It should be appreciated that the term “distal” and comparably related terms denoting further-away portions of an item are antonymous to proximal portions of the co-described item as those portions of items may be termed. The term “approximately” is intended to mean values within ten percent of the specified value.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” or “one of:” is used herein.

It should be understood that the use of “or” in the present application is with respect to a “non-exclusive” arrangement unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, when referring to a set or group of items, for illustration (A, B, C) the term “at least one or more . . . and . . . ” such as in “at least one or more of A, B, and C” is intended to include any to all of the denoted set or group of items, i.e. it could include just one item from the set or group, it could include all of the items from the set or group, and it could include any other combination of the set or group of items that is greater than one item and less than all of the items, the illustrated example having three items meaning there are up to seven non-ordered combinations A, B, C, AB, AC, BC, ABC. Other numbers of items would have maximum combination possibilities calculated accordingly.

Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

While inventive concepts have been described above in terms of specific embodiments, it is to be understood that the inventive concepts are not limited to these disclosed embodiments. Upon reading the teachings of this disclosure, many modifications and other embodiments of the inventive concepts will come to mind of those skilled in the art to which these inventive concepts pertain, and which are intended to be and are covered by both this disclosure and the appended claims. It is indeed intended that the scope of the inventive concepts should be determined by proper interpretation and construction of the appended claims and their legal equivalents, as understood by those of skill in the art relying upon the disclosure in this specification and the attached drawings.

As a decision support tool, the disclosed invention is ultimately designed to allow users to select for potential purchase at least one real estate property which may then be categorized as user sets of at least one real estate property. Such may include personalized recommendations: a section displaying a list of suggested homes based on the user's criteria and preferences; market analysis: charts and graphs showing current market trends, property value trends, and comparison of similar properties; property details: detailed information about each recommended home, including photos, descriptions, floor plans, and key features; neighborhood insights: information on schools, crime rates, amenities, commute times, and community reviews; financial analysis: tools to calculate mortgage options, property taxes, maintenance costs, and potential ROI; risk assessment: evaluation of environmental risks, market risks, and neighborhood safety; interactive map: a map highlighting the location of properties, points of interest, and commute routes; customizable filters: options to adjust search criteria such as price range, number of bedrooms, square footage, and proximity to work or schools; comparison tool: functionality to compare multiple properties side-by-side based on various metrics; and chatbot assistance: an interactive assistant to answer questions, provide additional information, and guide users through the home selection process.

Invention use cases include but are not limited to:

### Natural Language Processing (NLP) Models:

Large Language Models (LLMs) that are designed to automatically generate compelling and detailed property descriptions, answer user queries about properties and the market, and provide personalized recommendations based on user interactions.

Offer Generation: Automatically generating customized offers for buyers based on property details, buyer preferences, and historical data of similar successful offers.

Contract Drafting: Creating initial drafts of legal documents and contracts based on transaction details, reducing the workload on agents, and ensuring accuracy.

Virtual Agent Assistants: Providing real-time assistance to agents by answering complex queries, suggesting responses, and offering negotiation tips during interactions with clients.

Market Insights Reports: Generating detailed market insights reports for agents and clients, summarizing key trends, price forecasts, and investment opportunities.

Sentiment Analysis Models: Analyzing user feedback from reviews, social media, and surveys to gauge customer satisfaction and identify areas for service improvement.

Text Classification Models: Categorizing and tagging listings, user inquiries, and feedback for better organization and enhanced searchability on the platform.

### Predictive Analytics Models:

Regression Models: Predicting property prices based on historical sales data, current market trends, and specific property features to help set competitive listing prices.
Time Series Analysis: Forecasting market trends, property values, and user engagement over time to assist in strategic planning and decision-making.
Classification Models: Predicting the likelihood of offer acceptance, user conversion rates, and potential actions of buyers and sellers to optimize transaction processes.

### Recommendation Systems:

Collaborative Filtering: Recommending properties to users based on the preferences and behaviors of similar users, enhancing the personalized user experience.
Content-Based Filtering: Recommending properties based on specific features and characteristics that align with a user's past interactions and preferences.

### Clustering Models:

K-Means Clustering: Segmenting users, properties, and market data into distinct groups for targeted marketing campaigns and personalized recommendations.
Hierarchical Clustering: Providing detailed and nested segmentation of data to understand complex patterns in user behavior and market dynamics.

### Optimization Models:

Linear Programming: Optimizing marketing spend, property pricing strategies, and resource allocation to maximize efficiency and profitability.
Genetic Algorithms: Finding optimal solutions in complex, multi-variable environments, such as setting dynamic “Buy It Now” prices during live auctions.

### Deep Learning Models:

Convolutional Neural Networks (CNNs): Analyzing property photos to assess conditions, features, and attractiveness, which helps in enhancing listings and marketing strategies.
Recurrent Neural Networks (RNNs): Analyzing sequential data like user interaction histories and time series forecasting for better user engagement and market predictions.

### Reinforcement Learning Models:

Q-Learning: Developing strategies in dynamic environments, such as optimizing pricing and negotiation tactics based on ongoing interactions and feedback.
Deep Reinforcement Learning: Continuously improving models based on real-time interactions and outcomes, adapting user engagement strategies dynamically.

### Anomaly Detection Models:

Isolation Forests: Detecting unusual patterns in user behavior, identifying fraudulent activities, or spotting irregularities in market data to maintain platform integrity.
Autoencoders: Identifying anomalies in complex datasets, such as outlier properties or suspicious transactions, to ensure data quality and security.

### Graph Models:

Graph Neural Networks: Modeling relationships between users, properties, and agents to understand network effects and influence in the real estate market.
Community Detection Algorithms: Identifying clusters of similar properties or user communities to aid in targeted marketing and personalized recommendations.

### Explainable AI (XAI) Models:

SHAP (SHapley Additive explanations): Providing transparency by explaining the output of complex models, building trust with users by showing how decisions are made.
LIME (Local Interpretable Model-agnostic Explanations): Offering local explanations for individual predictions, helping users and agents understand AI-driven decisions and improve decision-making.

### Ensemble Models:

Random Forests: Improving prediction accuracy and robustness by combining multiple decision trees for tasks such as property price predictions and user behavior analysis.
Gradient Boosting Machines: Enhancing predictive performance by sequentially building models to correct errors of previous ones, useful for complex predictive tasks like offer acceptance likelihood.

Reverting to the drawings, FIG. 1 illustrates decision support tool 10 for real estate selection having at least one computer system 100 having controller assembly 102, memory assembly 104, and user interface 106. Decision support tool 10 is designed to assist potential homebuyers in making informed choices by integrating and analyzing various data sources and variables. Utilizing large language models (LLMs) 160 and advanced data analytics, the decision support tool 10 is designed to process real estate listings, market trends, neighborhood statistics, and user preferences to provide personalized recommendations. Decision support tool 10 is designed to synthesize information on spatial, temporal, material, risk, and financial factors to evaluate properties comprehensively, offering insights into a home's market value, potential appreciation, and suitability based on individual buyer criteria. Additionally, decision support tool 10 is designed to generate reports, answer specific queries, and simulate negotiation scenarios, enhancing the buyer's decision-making process with data-driven support.

Decision support tool 10 further may integrate machine learning program 142, Large Language Model (LLM) 160, user vectors, and customizable filters within computer system 100 to generate personalized real estate property recommendations. Machine learning program 142, executed on controller assembly 102, processes content database 110 containing data on real estate properties 220, see FIG. 2, including spatial variables (e.g., location coordinates, proximity to amenities), temporal variables (e.g., property age, market trends), material variables (e.g., construction quality, number of bedrooms), risk variables (e.g., flood risk scores, neighborhood crime rates), and financial variables (e.g., purchase price, estimated ROI). Machine learning program 142 constructs user vectors, which are numerical representations of user preferences and property attributes, by combining manually entered user inputs (e.g., desired price range, number of bedrooms) with predicted data derived from historical user interactions and market trends. These user vectors are stored in memory assembly 104 and used to rank and filter properties.

FIG. 2 illustrates content database 110 of real estate properties 220, which includes spatial, temporal, material, risk, and financial variables for a set of at least one real estate property 225 from the real estate properties 220, wherein the at least one real estate property 225 can include a set of at least one real estate property 225 with at least one second real estate property 230. Real estate properties 220, in representative embodiments, refer to homes but can refer to other real estate. The invention involves sorting real estate properties into sets and subsets related by variables. Real estate properties 220 generally refer to a universal set of all real estate properties 220 under consideration. At least one real estate property 225 from the real estate properties 220 generally refers to a set of real estate properties drawn from the set of all real estate properties under consideration. At least one second real estate property 230 generally refers to a real estate property also drawn from the set of all real estate properties 220 under consideration that may also be included within the set of at least one real estate property 225 as a union, partial union, or disjointed set and affords that any one of at least one real estate property 225 may be compared with at least one second real estate property 230. A given house may, depending on the given analysis, be considered among the set of real estate properties 220, at least one real estate property 225, and at least one second real estate property 230 as is necessary in that given analysis for selecting the given house, not selecting the given house, and comparing the given house with another given house or a set including the given house with a set including another house. If needed for an analysis, the above sets can be included and may combine at least one third real estate property to at least one n real estate property for a total range of compared houses 1, 2, . . . , n. These definitions are in accord with mathematical set theory wherein a given analysis typically starts from a finite set with a limited number of elements in at least one database of real estate properties.

The invention includes data from a wide variety of sources within a wide number of variables which may include, but not be limited to:

### Dependent and Independent Variables:

Independent Variable: A variable that represents the input or cause and is not affected by other variables in the experiment or function.
Dependent Variable: A variable that represents an output or effect and is dependent on the independent variable.

### Continuous and Discrete Variables:

Continuous Variable: A variable that can take any value within a given range. Examples include temperature, height, and time.
Discrete Variable: A variable that can only take specific, distinct values, often integers. Examples include number of students in a class, numbers of cars, and outcome of rolling a die.

### Categorical Variables:

Nominal Variable: A type of categorical variable with no intrinsic ordering among its categories. Examples include gender, race, or the make of a car.
Ordinal Variable: A type of categorical variable with a clear, ordered relationship between its categories. Examples include ranks (e.g., first, second, third) or levels of satisfaction (e.g., low, medium, high).

### Binary Variables:

Binary Variable: A variable that has only two possible values, often denoted as 0 and 1, true and false, or yes and no. Examples include outcomes of a coin toss (heads or tails) or whether a switch is on or off.

### Random and Deterministic Variables:

Random Variable: A variable where possible values are outcomes of a random phenomenon. It can be discrete (e.g., the number of heads in coin tosses) or continuous (e.g., the amount of rainfall in a month).
Deterministic Variable: A variable whose value is determined by a specific rule or formula and is not subject to randomness.

### Dummy Variables:

Dummy Variable: A binary variable used in statistical modeling to represent categorical data, typically in regression analysis. It takes values of 0 or 1 to indicate the absence or presence of a categorical effect.

### Latent Variables:

Latent Variable: A variable that is not directly observed but is inferred or estimated from other variables. Latent variables may be used to represent abstract concepts like intelligence or socio-economic status.

### Exogenous and Endogenous Variables:

Exogenous Variable: A variable that is determined outside the model and is not influenced by other variables in the system. In economic models, these are inputs from outside the real estate properties being studied.
Endogenous Variable: A variable that is determined within the model and is influenced by other variables in the system. These are typically the outcomes or outputs of the model.

### Control Variables:

Control Variable: A variable that is kept constant or regulated in an experiment to ensure that the effect of the independent variable on the dependent variable is accurately measured.

### Parameter Variables:

Parameter: A variable that characterizes a certain aspect of a system or function but is considered a constant within a specific context. Examples include coefficients in a regression model or the mean and standard deviation in a normal distribution.

Variables will be selected as relevant to a decision a user makes and may constitute information about the use as well as information about real estate such as homes. In the context of housing real estate, data, and associated variables can be broadly categorized into sets of spatial, temporal, material, risk, and financial variables, which encompass various factors related to a given house and its broader environment. Definitions with representative examples include, but are not limited to:

Spatial Variables: Spatial variables typically refer to the physical and geographical characteristics of a house and its surrounding environment. These include, but are not limited to:
Location: The specific address or area where the house is situated.
Proximity to Amenities: Distance to essential services such as schools, hospitals, grocery stores, and recreational areas.
Commute Distance: The distance and travel time between the house and the homeowner's place of work.
Neighborhood Characteristics: Features of the community such as safety, demographic composition, and overall atmosphere.
Lot Size and Layout: The size of the property and the arrangement of the house and yard.
Dimensions of the home: The layout and square footage of the house.

Temporal Variables: Temporal variables involve time-related aspects of housing and the real estate market. These include, but are not limited to:
Market Trends: Changes in housing prices and demand over time.
Property Age: The age of the house and how it has aged or been maintained over the years.
Timing of Purchase: The impact of seasonal trends and economic cycles on housing availability and prices.
Future Development: Planned or potential future developments in the area that could affect property values and desirability.

Material Variables: Material variables encompass physical attributes and quality of houses. These include, but are not limited to:
Construction Quality: Materials and methods used in building the house.
Structural Integrity: Condition of the house's foundation, roof, plumbing, and electrical systems.
Design and Features: Architectural style, floor plan, number of rooms, and modern amenities such as updated kitchens or smart home technology.
Maintenance and Upgrades: Extent of upkeep and improvements made to the house over time.

Risk Variables: Risk variables pertain to potential uncertainties and hazards associated with the property. These include, but are not limited to:
Market Risk: Fluctuations in real estate market values that can affect property prices.
Environmental Risks: Susceptibility to natural disasters such as floods, earthquakes, or hurricanes.
Neighborhood Safety: Crime rates and other safety concerns in the surrounding area.

Financial Risk: Potential for financial loss due to changes in interest rates, property taxes, or homeowners' insurance costs. Financial variables relate to the economic aspects of buying, owning, and maintaining a house. These include, but are not limited to:
Purchase Price: Cost to buy the house.
Mortgage Terms: Loan interest rates, duration, and monthly payment obligations.
Property Taxes: Annual taxes levied on the property by local governments.
Maintenance Costs: Ongoing expenses for repairs, utilities, and general upkeep of the property.
Return on Investment (ROI): Potential for property value appreciation and resale value.
Insurability: The cost and availability of financial protections.

The at least one real estate property 225 is from the set termed at least one real estate property 225 and is designed to be compared with at least one second real estate property 230 from real estate properties 220. Comparison of real estate properties 220 can take place through the creation of vector variables. Creating vectors and vector variables from spatial, temporal, material, risk, and financial variables involves organizing these variables into structured numerical forms that can be used in mathematical and computational models. Illustrations of how vectors can be created from each category of variables include, but are not limited to:

### Spatial Variables:

Components: Distance to work, distance to schools, proximity to amenities, neighborhood safety index, lot size.
Vector Creation: Combines components into a spatial vector. For a representative example, a spatial vector s could be represented as: s=[d_{work},d_{school},pₐₘₑₙᵢₜᵢₑₛ,n_{safety},l_{size}] where each element represents a specific spatial variable measured in appropriate units (e.g., kilometers for distances, a safety index score).

### Temporal Variables:

Components: Property age, market trend indices, timing of purchase (e.g., year, quarter), future development indicators.
Vector Creation: Organizes components into a temporal vector. For a representative example, a temporal vector t could be: t=[a_{property},m_{trend},t_{purchase},f_{development}] where each element represents a specific temporal variable measured in years, indices, or binary indicators for development plans.

### Material Variables:

Components: Construction quality index, number of bedrooms, number of bathrooms, floor area, presence of modern amenities (e.g., 1 if present, 0 if absent).
Vector Creation: Combines material components into a vector m. For a representative example: m=[q_{construction},n_{bedrooms},n_{bathrooms},fₐᵣₑₐ,a_{modern}] where each element represents a material characteristic, with appropriate units for continuous variables and binary values for presence/absence indicators.

### Risk Variables:

Components: Market risk score, environmental risk scores (e.g., flood risk, earthquake risk), neighborhood safety risk, financial risk index.
Vector Creation: Assembles risk components into a risk vector r. For a representative example: r=[mᵣᵢₛₖ,e_{flood},e_{earthquake},n_{safety},fᵣᵢₛₖ] where each element represents a specific risk variable, often normalized to a common scale or index.

### Financial Variables:

Components: Purchase price, mortgage interest rate, property taxes, maintenance costs, estimated ROI.
Vector Creation: Combines financial components into a financial vector f. For a representative example: f=[p_{price},iᵣₐₜₑ,fₜₐₓₑₛ,m_{costs},e_{ROI}] where each element represents a financial metric, measured in currency units or percentages.

### Example of Vector Variables in a Machine Learning Context

In a machine learning context, these vectors can be combined into larger feature vectors x for each house. For example, if considering all categories together, a representative example of a complete feature vector x might be:
x=[d_{work},d_{school},pₐₘₑₙᵢₜᵢₑₛ,n_{safety},I_{size},a_{property},m_{trend},t_{purchase},f_{development},q_{construction},n_{bedrooms},n_{bathrooms},fₐᵣₑₐ,a_{modern},mᵣᵢₛₖ,e_{flood},e_{earthquake},n_{safety}, fᵣᵢₛₖ,p_{price},iᵣₐₜₑ,fₜₐₓₑₛ,m_{costs},e_{ROI}].

These representative user vectors collectively represent a comprehensive set of criteria that individuals consider when searching for their ideal home. By capturing and analyzing these vectors, real estate platforms and agents can tailor their recommendations to better match the specific preferences and needs of potential buyers or renters.

FIG. 1 further illustrates that at least one software program 140 is disposed on at least one computer system 100 designed to calculate user vectors wherein at least one machine learning program 142 is designed to build the set of at least one real estate property 225 from the real estate properties 220 to be presented to the user. In some embodiments of the decision support tool 10 for real estate selection, user vectors from at least one user are compared with at least one user vector from at least one other user. In some embodiments of the decision support tool 10 for real estate selection, user vectors include both manually entered data and predicted data.

Machine learning program 142 may use supervised and unsupervised learning techniques, such as regression models and clustering algorithms, to build set of at least one real estate property 225 from content database 110. For example, a gradient boosting model predicts property suitability scores based on weighted combinations of user vectors, which encapsulate preferences such as proximity to schools (e.g., within 5 miles) and budget constraints (e.g., $300,000-$500,000). LLM 160, such as a transformer-based model fine-tuned on real estate listing texts, enhances this process by extracting and tagging property attributes (e.g., “modern kitchen” tagged as a material variable) from unstructured data in content database 110. LLM 160 processes textual inputs, such as property descriptions and user queries, to generate contextual tags (e.g., “LOC” for location, “FINANCIAL” for price) and descriptive summaries, which are integrated into the user vectors to refine property rankings.

Common user vectors used to determine the type of house a person wants typically include a combination of preferences, criteria, and characteristics that reflect their ideal living situation. Representative examples include:

Location Preferences: L_{geo}=(l₁,l₂, . . . , lₙ)
Geographic Area: Desired city, neighborhood, or region.
Proximity to: Workplaces, schools, public transportation, and amenities (like parks or shopping centers).
   Property Characteristics: P_{type}=(p₁,p₂, . . . , pₙ)
Type of Property: House, apartment, condominium, townhouse, etc.
Size: Number of bedrooms, bathrooms, square footage.
Features: Specific amenities such as a garage, backyard, swimming pool, or updated kitchen.
   Budget and Financial Considerations: B_{fin}=(b₁,b₂, . . . , bₙ)
Price Range: Maximum budget for purchasing or renting.
Mortgage or Rent: Affordability of monthly payments.
Maintenance Costs: Considerations for ongoing expenses like property taxes and utilities.
   Lifestyle Preferences: F_{fam}=(f₁,f₂, . . . , fₙ)
Family Size: Suitable accommodation for individuals, couples, families, or roommates.
Community Attributes: Desirable characteristics like safety, school quality, and recreational facilities.
Environmental Factors: Preferences for urban, suburban, or rural settings.
   Temporal Considerations: Tₜₑₘₚ=(t₁,t₂, . . . , tₙ)
Timeline: Urgency of moving or desired time frame for relocation.
Future Plans: Long-term considerations such as potential for expansion, resale value, or investment potential.
   Personal Preferences: Per_{pref}=(per₁,per₂, . . . , perₙ)
Style and Design: Architectural preferences (e.g., modern, traditional, historic).
Condition: New construction vs. established homes, renovation potential.
   Risk and Safety Preferences: R_{safe}=(r₁,r₂, . . . , rₙ)
Neighborhood Safety: Concerns about crime rates, and environmental risks.
Property-specific Risks: Considerations such as flood zones or earthquake-prone areas.
   Accessibility and Mobility: A_{access}=(a₁,a₂, . . . , aₙ)
Accessibility Needs: Requirements for wheelchair accessibility, elevator access, or single-floor living, or other like accommodations associated with additional features related to improved accessibility.

User interface 106 is designed to receive inputs and present outputs wherein users may create user sets of at least one selected real estate property from the real estate properties 220.

Vectors provide the basis by which machine learning algorithms may make appropriate comparison such as, but not limited to:
Cosine Similarity, which measures the cosine of the angle between two vectors. It is defined as: Cosine Similarity=A·B/∥A∥∥B∥, where A·B is the dot product of vectors A and B, and ∥A∥∥B∥ are the magnitudes (norms) of the vectors.
Euclidean Distance, which measures the “straight-line” distance between two vectors in Euclidean space. It is defined as: Euclidean Distance=(Σᵢ=1n(Aᵢ−Bᵢ)²)^{1/2}.
Jaccard similarity, which measures the similarity between finite sample sets, is defined as: Jaccard Similarity=|A∩B|/|A∪B|

Customizable filters, accessible via the user interface 106 and dashboard 150, may enable users to dynamically condition the range of variables used in property selection. For instance, a user may set a filter to limit properties to those with a commute time of less than 30 minutes (spatial variable) or a purchase price below $400,000 (financial variable). These filters are implemented as constraints on the user vectors, adjusting the weights of vector components in real time. Machine learning program 142 recalculates property rankings by applying cosine similarity or Euclidean distance metrics to compare filtered user vectors with property vectors derived from the content database 110. For example, a user vector [0.8, 0.5, 0.3, 0.1, 0.9] representing preferences for location, bedrooms, price, risk, and ROI is compared to property vectors to identify the top-matching properties.

Other measures include but are not limited to Manhattan Distance (L1 Distance) which is known as L1 distance or city block distance, which is the sum of the absolute differences of their coordinates; Minkowski Distance, which is a generalization of both Euclidean and Manhattan distances; Hamming Distance, which is the number of positions at which the corresponding elements are different; Mahalanobis Distance, which is a measure of the distance between a point and a distribution; Pearson Correlation Coefficient, which is a correlation measures the linear correlation between two vectors; and Dot Product, taken independently, which are measures the similarity of two vectors in terms of their magnitude and direction.

FIG. 1 further illustrates that embodiments of decision support tool 10 for real estate selection may include user interface 106 having dashboard 150 designed to present at least one or more of: personalized recommendations, market analysis, property details, neighborhood insights, financial analysis, risk assessments, interactive maps, customizable filters: comparison Tool, and a human or chatbot Assistance. In some embodiments of decision support tool 10 for real estate selection, dashboard 150 includes customizable filters designed to condition the range of at least one or more of spatial, temporal, material, risk, and financial variables.

FIG. 1 further illustrates that in some embodiments of decision support tool 10 for real estate selection, user interface 106 is designed to include, present, and record video imagery 155 of at least one real estate property 225. In some embodiments of decision support tool 10 for real estate selection, video imagery 155 is created and presented substantially in real time. Some embodiments of decision support tool 10 for real estate selection include at least one or more of photographic and computer-generated visual data.

In some embodiments of decision support tool 10 for real estate selection, data for each at least one real estate property 225 is tagged by way of Large Language Model 160. Large language models (LLMs) 160 can be designed to tag data through a process called named entity recognition (NER) or entity tagging.

Included is training data preparation: Annotated datasets are prepared where each entity (such as location names, dates, organizations, etc.) in the text is labeled with its corresponding tag (e.g., LOC for location, DATE for date). Included is fine-tuning LLM 160, wherein the pre-trained LLM (like GPT-3 or BERT) is fine-tuned on the annotated dataset using supervised learning techniques. During fine-tuning, LLM 160 learns to predict correct tags for entities in the text. Adjustments are made to LLM 160 parameters to fine-tune performance for the specific tagging task. Included may be token-level tagging, wherein LLM 160 processes text at the token level, meaning each word or subword piece is analyzed independently. During tagging, LLM 160 predicts the probability distribution over possible tags for each token in the input text. Tags may be assigned based on the highest probability prediction for each token. Included may be contextual interpretation, wherein LLM 160 leverages contextual interpretations of language to improve tagging accuracy. They consider the surrounding words and sentences to infer the correct tags for ambiguous or complex entities. Contextual clues may help in disambiguating entities with multiple meanings or usages. Included may be output generation, wherein after tagging, LLM 160 generates output where entities in the text are marked with their respective tags. For example, in the sentence, “New York City is a vibrant metropolis,” LLM 160 might tag “New York City” as a location (LOC). Included may be evaluation and refinement, wherein the performance of the adapted LLM 160 is evaluated using metrics such as precision, recall, and F1-score on a validation set. Iterative refinement and adjustments may be made to enhance tagging accuracy.

LLMs 160 can tag listings for analyzed homes on the market by performing named entity recognition (NER) or entity tagging on the textual descriptions and details provided in the listings. Representative embodiments may include text preprocessing, wherein the textual content of each listing, which typically includes descriptions of the property, neighborhood, amenities, and other details, is prepared for analysis. Included may be tokenization, wherein the text is tokenized into individual words or subword pieces, which allows LLM 160 to process each unit of text independently. Included may be named entity recognition (NER), wherein could be included location tagging, wherein LLM 160 identifies and tags names of locations mentioned in the listings (e.g., city names, neighborhood names) as entities labeled with a ‘LOC’ tag; temporal tagging, wherein dates and temporal references such as “built in 2005” or “recently renovated” can be tagged with ‘DATE’ or other relevant temporal tags; material tagging, wherein descriptions of materials used in construction, architectural styles, or specific amenities like “hardwood floors” can be tagged with ‘MATERIAL’ or related tags; risk tagging, wherein information related to safety features, neighborhood crime rates, or environmental risks can be tagged with appropriate risk-related tags (‘RISK’); financial tagging, wherein details about price, mortgage terms, property taxes, and ROI estimates can be tagged with ‘FINANCIAL’ or relevant financial tags; and contextual interpretation: LLM 160 leverages assessment of contextual language to accurately tag entities based on the context provided in the listings. For example, interpreting that “Park Avenue” refers to a location rather than a generic term.

The LLM 160 further supports property scoring by generating a suitability score 165 for each real estate property 225. The scoring process combines outputs from machine learning program 142 and LLM 160. For example, the machine learning program 142 calculates a preliminary score based on numerical variables (e.g., price, square footage), while the LLM 160 adjusts the score by analyzing qualitative data, such as positive sentiment in listing descriptions (e.g., “newly renovated”) or negative feedback in user reviews (e.g., “needs repairs”). The dashboard 150 presents these scores alongside interactive visualizations, such as bar charts comparing properties based on user-defined filters, enabling users to refine selections. The user interface 106 records user interactions with filters and scores, feeding this data back to the machine learning program 142 to iteratively improve vector predictions and recommendations.

In some embodiments of the decision support tool 10 for real estate selection, each at least one real estate property 225 is given at least one score 165. LLM 160, in representative embodiments, is designed to score given real estate properties 220 listed for sale based on various factors by leveraging their ability to process and analyze textual descriptions, data points, and contextual information. Representative scoring could include, but not be limited to: feature extraction, wherein LLM 160 begins by extracting relevant features from the listing text, including spatial (location, proximity to amenities), temporal (property age, market trends), material (construction quality, amenities), risk (safety ratings, environmental factors), and financial (price, mortgage terms) variables; normalization, wherein numeric data such as prices, areas, and ratings are normalized to a consistent scale or format to facilitate comparison; weighting factors, wherein LLM 160 is designed to assign weights to different features based on their importance in the scoring process. For example, proximity to good schools might carry more weight for families, while financial affordability might be crucial for budget-conscious buyers; contextual interpretation, wherein LLM 160 uses its contextual interpretation to interpret nuances in the listing text, such as distinguishing between positive and negative descriptions (e.g., “charming older home” vs. “dated property”); scoring models, wherein LLM 160 develops a scoring model that integrates the weighted features and contextual interpretation that could be based on a regression approach, ensemble models, or neural networks; output Interpretation: Generate a numerical score 165 or ranking for the house based on the scoring model. This score 165 reflects the overall attractiveness or suitability of the property based on the analyzed factors; visualization and explanation, wherein LLM 160 is designed to provide visual representations (such as charts or graphs) and textual explanations of how each factor contributes to the score 165, helping users to understand the rationale behind the scoring and make informed decisions; and iterative refinement, wherein LLM 160 is designed to continuously refine the scoring model based on feedback, additional data, and changing market conditions to improve accuracy and relevance.

In predicting whether a person will like a given real estate property from a set of real estate properties, Baye's Theorem or comparable methods are used. For a representative illustration, if S is the set of real estate properties 220 and a subset of items TES where T is the at least one real estate property 225. Decision support tool 10 is designed to calculate the probability that a user will like a given at least one second real estate property 230, which for this illustration is a given real estate property A from T wherein probability A is based on event B where B is determined from properties already evaluated, scored, or given a known value for the user from T⊆S—i.e. known information B is used to predict an unknown desirability of A. Therefore, P(A|B)=(P(B|A)*P(A))/P(B) where information about A and B includes vectors. Further, complex calculations may be linearized to produce estimates, for example, linear least mean squares estimation through which calculations can be streamlined.

### Benefits and Applications

Standardization: Vectors allow for the standardization of the diverse data types used in the invention to render those variables into a uniform format.

Computational Efficiency: Vectors can be processed efficiently using linear algebra operations, making them suitable for machine learning algorithms.

Integration: Combining variables from different categories into a single vector facilitates integrated analysis and modeling.

By structuring variables into vectors, they can be used in various mathematical models, machine learning algorithms, and data analysis techniques to derive insights, make predictions, and improve decisions.

To establish variable values, the invention uses LLM 160 which can, for illustration, be employed to analyze a home on the market by processing and synthesizing vast amounts of textual data related to the property. LLM 160 is designed to evaluate real estate listings, agent descriptions, customer reviews, neighborhood analyses, and market trends that can be combined with such hard data as the size and floor plan of a home. By analyzing and extracting information from this data, LLM 160 is designed to generate comprehensive reports that highlight the strengths and weaknesses of a property, predict its market value, and assess its potential for appreciation. Additionally, LLM 160 is designed to answer specific questions from potential buyers about the home and its surroundings, offer personalized recommendations, and even simulate negotiation scenarios to help buyers make informed decisions.

Use cases for LLM 160 include, but are not limited to:

Automated Listing Creation: Automatically generate property listings based on structured input data such as property features, location, and historical data. LLM 160 may be designed to craft compelling descriptions that highlight the unique aspects of each property.

Personalized User Recommendations: Provide personalized property recommendations by analyzing a user's interaction history, preferences, and search queries. LLM 160 may be designed to generate suggestions that align with the user's needs and interests.

Dynamic Market Newsletters: Create customized newsletters for users, featuring market trends, new listings, and investment opportunities. LLM 160 may be designed to compile and summarize data to produce informative and engaging content tailored to each user.

Virtual Real Estate Assistant: Implement a virtual assistant that can answer user queries, provide property information, and guide users through the buying or renting process. LLM 160 may be designed to interpret and respond to natural language inputs, offering real-time support.

Interactive Property Descriptions: Generate interactive and detailed property descriptions that adjust based on user queries and interactions. Users can ask questions about specific features or aspects of a property, and LLM 160 may be designed to provide detailed responses.

Client Follow-Up Emails: Draft follow-up emails for real estate agents to send to clients after property viewings or consultations. LLM 160 may be designed to create personalized and professional messages that summarize meetings and outline next steps. Market Analysis Reports: Produce detailed market analysis reports by summarizing large datasets, news articles, and economic reports. LLM 160 may be designed to generate insights and forecasts based on current market conditions, helping agents and clients make informed decisions.

Content Generation for Blogs and Social Media: Automatically generate content for blogs and social media posts related to real estate trends, tips for buyers and sellers, and market updates. LLM 160 may be designed to create engaging and informative articles that attract and retain audience interest.

Training and Onboarding Materials: Develop comprehensive training and onboarding materials for new real estate agents. LLM 160 may be designed to create guides, manuals, and FAQs that help new hires quickly get up to speed with company processes and industry best practices.

Legal Document Drafting: Assist in drafting legal documents such as contracts, agreements, and disclosures. LLM 160 may be designed to generate standard templates and customize them based on specific transaction details, ensuring compliance and accuracy.

Automated Customer Surveys: Create and analyze customer surveys to gather feedback on services and user experience. LLM 160 may be designed to generate survey questions, compile responses, and provide summaries and insights based on the collected data.

Real Estate Investment Insights: Provide insights and analysis for real estate investors by generating detailed reports on potential investment properties. LLM 160 may be designed to evaluate factors like ROI, market trends, and property performance to help investors make informed decisions.

Real-Time Translation Services: Offer real-time translation services for non-English speaking clients. LLM 160 may be designed to translate property descriptions, contracts, and communications, making it easier for agents to serve a diverse clientele.

User Profile Summaries: Generate detailed summaries of user profiles, highlighting their preferences, past interactions, and potential needs. LLM 160 may be designed to compile this information to help agents tailor their services and communication strategies.

Scenario-Based Simulations: Create scenario-based simulations for buyers and sellers, such as potential market changes, price adjustments, and negotiation outcomes. LLM 160 may be designed to generate narratives and outcomes based on different scenarios, helping clients visualize possibilities.

### LLM+Model

Advanced Property Descriptions: LLM 160+Sentiment Analysis: May be designed to generate engaging property descriptions by incorporating positive sentiment from user reviews and feedback. This may be designed to help highlight aspects of properties that users have found most appealing, enhancing the attractiveness of listings while complying with local MLS or Associate rules.

Intelligent Offer Creation: LLM 160+Predictive Scoring Models: May be designed to automatically draft offers by generating the initial terms based on the buyer's preferences and financial status. Predictive scoring models can then evaluate the likelihood of offer acceptance, allowing users to fine-tune the terms for better chances of success.

Personalized Communication: LLM 160+Text Classification: May be designed to create personalized email and SMS communication for agents to send to clients. Text classification models can categorize client queries and LLM 160 may be designed to draft personalized responses, ensuring timely and relevant communication.

Dynamic Contract Generation: LLM 160+Rule-Based Systems: May be designed to generate real estate contracts and legal documents tailored to specific transactions. LLMs 160 may be designed to draft the language while rule-based systems ensure all necessary legal clauses and compliance requirements are included.

Enhanced Virtual Tour Narration: LLM 160+Image Recognition (CNNs): This may provide dynamic narrations for virtual tours by generating descriptions based on recognized features and highlights of the property. CNNs identify key elements in images, and LLM 160 creates an engaging tour experience for potential buyers.

Market Analysis Reports: LLM 160+Time Series Analysis: May be designed to generate comprehensive market analysis reports that include both current data and future predictions. LLM 160 may be designed to compile and explain the data in a user-friendly format, while time series analysis provides the necessary market forecasts.

Buyer and Seller Guidance: LLM 160+Reinforcement Learning: May be designed to provide buyers and sellers with tailored advice on negotiation strategies and pricing. Reinforcement learning models may be designed to simulate different negotiation scenarios, and LLM 160 may be designed to draft personalized advice based on these simulations.

Property Investment Analysis: LLM 160+Regression Models: May be designed to generate detailed investment analysis reports for potential real estate investors. Regression models predict future property values and rental yields, while LLM 160 may be designed to compile this data into comprehensive and easy-to-understand reports.

User Education and FAQs: LLM 160+Clustering Models: May be designed to create a dynamic FAQ section and educational resources for users based on common queries and topics. Clustering models group similar questions, and LLM 160 may be designed to generate detailed and informative answers.

Real-Time Customer Support: LLM 160+Chatbots: May be designed to implement AI-driven chatbots to handle customer inquiries in real time. LLM 160 may be designed to provide natural language interpreting and response generation, while chatbots manage the interaction flow, offering immediate assistance to users.

Automated Social Media Content: LLM 160+Sentiment Analysis: May be designed to automatically generate social media posts highlighting new listings, market trends, and success stories. Sentiment analysis ensures the content resonates positively with the audience, enhancing engagement and brand perception.

Interactive Property Comparison: LLM 160+Recommendation Systems: May be designed to generate interactive comparisons between multiple properties based on user preferences and market data. Recommendation systems identify the most relevant properties, and LLM 160 may be designed to create detailed comparative reports to aid decision-making.

### Representative Action Model Use Cases

Intelligent Follow-Up Actions: Suggest the next best actions for agents after client interactions, such as follow-up calls, emails, or scheduling another showing. This model can analyze client behavior and interaction history to recommend the most effective follow-up steps.

Dynamic Marketing Campaigns: Create dynamic marketing campaigns that adjust in real-time based on user interactions and engagement metrics. For instance, if a user shows interest in certain types of properties, the model may be designed to automatically adjust the marketing content to highlight similar listings.

Predictive Maintenance Scheduling: Predict and schedule maintenance for properties based on historical data, usage patterns, and inspection reports. This ensures properties remain in top condition, enhancing their appeal to potential buyers or renters.

Offer Optimization: Assist in optimizing offers by suggesting adjustments based on market conditions, property details, and buyer/seller behavior. This model may be designed to recommend changes to the offer price, contingencies, or terms to increase the likelihood of acceptance.

Personalized Buyer Journeys: Create personalized buyer journeys using an Action Model that tailors the user experience based on their preferences, interactions, and stages in the buying process. This model may be designed to include customized content, property recommendations, and timely notifications.

Real-Time Negotiation Assistance: Provide real-time negotiation assistance to agents and clients during offer discussions. This model may be designed to analyze the negotiation dynamics and suggest strategies to improve the chances of reaching a favorable agreement.

Proactive Client Retention: Identify at-risk clients and suggest proactive retention strategies. This model can analyze client engagement patterns and recommend actions such as personalized offers, loyalty rewards, or targeted communications to retain clients.

Showings and Open House Optimization: Optimize the scheduling and management of property showings and open houses. This model may be designed to recommend the best times and dates based on user availability, historical attendance data, and local events.

Transaction Process Automation: Automate various stages of the real estate transaction process, from offer submission to closing. This model may be designed to guide agents and clients through each step, ensuring compliance and efficiency.

Customized Training for Agents: Create customized training programs for agents using an Action Model that identifies skill gaps and recommends specific training modules. This model may be designed to track agent performance and suggest targeted training to improve their effectiveness.

Market Trend Adaptation: Help agents and clients adapt to changing market trends. This model may be designed to analyze market data and recommend actions such as price adjustments, marketing strategies, or investment opportunities.

Enhanced Customer Service: Enhance customer service by recommending actions based on client inquiries and feedback. This model may be designed to suggest responses, follow-up actions, or escalation steps to ensure high levels of customer satisfaction.

Lead Scoring and Prioritization: Score and prioritize leads based on their likelihood to convert. This model may be designed to analyze lead behavior, interaction history, and demographic data to help agents focus on the most promising opportunities.

Financial Planning Assistance: Assist clients with financial planning related to real estate transactions. This model may be designed to analyze client financial data and recommend actions such as mortgage options, budget adjustments, or investment strategies.

FIG. 3A-3C illustrates a representative decision support method for real estate selection including the step of 300, accessing a content database 110 of real estate properties 220 including spatial, temporal, material, risk, and financial variables for a set of at least one real estate property 225 from the real estate properties 220. The method includes the step of 305, creating a set of at least one real estate property 225. The method includes the step of 310, parsing the at least one real estate property 225 to include a set of at the least one real estate property with at least one second real estate property 230. The method includes the step of 315, comparing at least one real estate property 225 from the set of at least one real estate property 225 with at least one second real estate property 230 from the real estate properties 220. The method includes the step of 320, calculating user vectors by way of at least one software program 140 wherein at least one machine learning program 142 builds the set of at least one real estate property 225 from the real estate properties 220 to be presented to the user. The method includes the step of 325, receiving by way of the user interface 106 inputs wherein users may create user sets of at least one real estate property 225 from the real estate properties 220. The method includes the step of 330, presenting by way of the user interface 106 outputs wherein users may create user sets of at least one real estate property 225 from the real estate properties 220.

The method may include the step of 335, including presenting by way of a dashboard 150 at least one or more of: personalized recommendations, market analysis, property details, neighborhood insights, financial analysis, risk assessments, interactive Maps, customizable filters: comparison tool, and a human or chatbot assistance. The method may include the step of 340, conditioning the range of and filtering at least one or more of spatial, temporal, material, risk, and financial variables. The dashboard 150 may include customizable filters and filter toggles, dials, or other ways to denote conditions. Condition is a term associated with variables and filtering wherein variables are given a range of acceptability, for example, that a house must be within a certain distance from a city, have a certain minimum and maximum size, and may also be binary such as whether a house has or does not have a garage.

The method may include the step of 345, at least one or more of presenting and recording video imagery 155 of the at least one real estate property 225. The method may include the step of 350, including creating and presenting video imagery 155 substantially in real time. The method may include the step of 355, further including presenting at least one or more of photographic and computer-generated visual data. The method may include the step of 360, further including tagging at least one real estate property 225 by way of a Large Language Model 160. The method may include the step of 365, further including scoring each at least one real estate property 225 with at least one score 165. The method may include the step of 370, further including comparing user vectors from at least one user with at least one user vector from at least one other user. The method may include the step of 375, further including creating user vectors from both manually entered data and predicted data.

A general object of the invention is to improve buyer and seller decision cycles associated with real estate wherein from a vantage of increased visibility into real estate properties 120, users can assess, decide, and act on data provided in real time or as rapidly as data can be acquired or created, accounting for the fact that some acquired data may have a time lag based on updates of its source. A second object of the invention is to offer recommendations users can accept or deny, where the direction is for users to spend less time determining finding and determining which properties to review and more time conducting an aided assessment of those properties, deciding what to do about a given property, and acting on the decision. Decision support tool 10 is designed to make multiple parallel assessments with multiple variables which themselves may have multiple vector components, and an important advantage is the real time properties the tool provides the user.

FIG. 4 illustrates a representative user interface screen image of real estate property description.

FIG. 5 illustrates a representative user interface screen image of comparative real estate property listings.

FIG. 6 illustrates a representative user interface screen image of real estate property information.

FIG. 7 illustrates a representative user interface screen image of real estate property quick action page.

FIG. 8 illustrates a representative user interface screen image of real estate property pricing calculator.

Screenshots from FIGS. 4-8 are representative. Other screen images can be used. Screen images would be operationally enabled for user interaction for both receiving outputs, such as potentially suitable real estate properties and entering inputs such as information to use when filtering or selecting potentially suitable real estate properties.

Various related embodiments of the inventive concept are also described in the drawings, which are incorporated herein by reference in its entirety. The following U.S. patents and/or U.S. patent applications, are incorporated by reference herein in their entireties:
U.S. Pat. No. 11,587,174, issued Feb. 21, 2023;
U.S. Pat. No. 10,078,866, issued Sep. 18, 2018;
U.S. Pat. No. 8,005,733, issued Aug. 23, 2011;
U.S. Published Patent App. No. 2024/0070741, filed Aug. 30, 2022;
U.S. Published Patent App. No. 2023/0162302, filed Nov. 21, 2022;
U.S. Published Patent App. No. 2022/0405340, filed May 12, 2022;
U.S. Published Patent App. No. 2021/0248699, filed Feb. 7, 2020; and,
U.S. Published Patent App. No. 2007/0043770, filed Aug. 22, 2006.

Thusly, the embodiments shown and described are merely exemplary and various alternatives, combinations, omissions, of specific components, or foreseeable alternative components, understood by one having ordinary skill in the art, described in the present disclosure or within the field of the present disclosure, are intended to fall within the scope of the appending claims.

It will be appreciated that various aspects of the invention and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the claims.

### REPRESENTATIVE COMPONENTS

10 Decision support tool
100 Computer system
102 Controller assembly
104 Memory assembly
106 User interface
110 Content database
140 Software program
142 Machine learning program
150 Dashboard
155 Video imagery
160 Large Language Model
165 Score
220 Set of real estate properties
225 Set of at least one real estate property
230 Set of at least one second real estate property
300-375 Method steps

What is claimed is:

1. A decision support tool for real estate selection comprising:
at least one computer system having a controller assembly, memory assembly, and user interface;
a content database storing data of a plurality of real estate properties including spatial, temporal, material, risk, and financial variables for a set of at least one real estate property from said real estate properties;
wherein the at least one real estate property can comprise a set of at least one real estate property with at least one second real estate property;
wherein the computer system is configured to compare the at least one real estate property from the set of at least one real estate properties with the at least one second real estate property from the real estate properties;
at least one software program disposed on at least one computer system configured to calculate user vectors and property vectors wherein at least one machine learning program is configured to apply customizable filters, received via the user interface, to condition the user vectors by adjusting weights of the spatial, temporal, material, risk, or financial variables from which to build the set of at least one real estate property from said real estate properties to be presented to the user; and,
the user interface configured to receive inputs and present outputs wherein users may create user sets of at least one selected real estate property from said real estate properties.

2. The decision support tool for real estate selection of claim 1, wherein the user interface includes a dashboard configured to present at least one or more of: personalized recommendations, market analysis, property details, neighborhood insights, financial analysis, risk assessments, interactive maps, customizable filters: comparison tools, and a human or chatbot assistance.

3. The decision support tool for real estate selection of claim 1, wherein the dashboard includes customizable filters configured to condition the range of at least one or more of spatial, temporal, material, risk, and financial variables.

4. The decision support tool for real estate selection of claim 1, wherein the user interface is configured to include, present, and record video imagery of the at least one real estate property.

5. The decision support tool for real estate selection of claim 4, wherein the video imagery is created and presented substantially in real time.

6. The decision support tool for real estate selection of claim 1, further including at least one or more of photographic and computer-generated visual data.

7. The decision support tool for real estate selection of claim 1, wherein data for each at least one real estate property is tagged by way of a Large Language Model.

8. The decision support tool for real estate selection of claim 1, wherein each at least one real estate property is given at least one score.

9. The decision support tool for real estate selection of claim 1, wherein user vectors from at least one user is compared with at least one user vector from at least one other user.

10. The decision support tool for real estate selection of claim 1, wherein user vectors include both manually entered data and predicted data.

11. A decision support method for real estate selection comprising:
accessing a content database of real estate properties including spatial, temporal, material, risk, and financial variables for a set of at least one real estate property from said real estate properties,
creating a set of at least one real estate property;
parsing the at least one real estate property to include a set of at the least one real estate property with at least one second real estate property;
comparing at least one real estate property from the set of at least one real estate properties with the at least one second real estate property from said real estate properties;
calculating user vectors by way of at least one software program wherein at least one machine learning program builds the set of at least one real estate property from said real estate properties to be presented to the user;
receiving by way of the user interface inputs wherein users may create user sets of at least one real estate property from said real estate properties; and,
presenting by way of the user interface outputs wherein users may create user sets of at least one real estate property from said real estate properties.

12. The decision support method for real estate selection of claim 11, including presenting by way of a dashboard at least one or more of: personalized recommendations, market analysis, property details, neighborhood insights, financial analysis, risk assessments, interactive maps, customizable filters: comparison tools, and human or chatbot assistance.

13. The decision support method for real estate selection of claim 11, including conditioning the range of and filtering at least one or more of spatial, temporal, material, risk, and financial variables.

14. The decision support method for real estate selection of claim 11, including at least one or more of presenting and recording video imagery of the at least one real estate property.

15. The decision support method for real estate selection of claim 14, including creating and presenting video imagery substantially in real time.

16. The decision support method for real estate selection of claim 11, further including presenting at least one or more of photographic and computer-generated visual data.

17. The decision support method for real estate selection of claim 11, further including tagging at least one real estate property by way of a Large Language Model.

18. The decision support method for real estate selection of claim 11, further including scoring each at least one real estate property with at least one score.

19. The decision support method for real estate selection of claim 11, further including comparing user vectors from at least one user with at least one user vector from at least one other user.

20. The decision support method for real estate selection of claim 11, further including creating user vectors from both manually entered data and predicted data.
